(19) United States
(12) Patent Application Publication
(10) Pub. No.: US 2011/0153514 A1
(43) Pub. Date: Jun. 23, 2011

(54) Generating Customer-Specific Solution Documentation

(75) Inventors: Eric M. Chan, Scarborough (CA); Jinchao Huang, Markham (CA); John W. Sweitzer, Austin, TX (US); Yi-Hsiu Wei, Austin, TX (US)

(73) Assignee: INTERNATIONAL BUSINESS MACHINES CORPORATION, Armonk, NY (US)

(21) Appl. No.: 12/642,758

(22) Filed: Dec. 18, 2009

(51) Int. Cl. G06Q 10/00

(52) U.S. Cl. 705/342

(57) ABSTRACT

The disclosed techniques enable a customer or solution provider to generate customer-specific solution documentation according to an organizational design corresponding to a customer from generic, or “out-of-the-box,” documentation. A solution package includes an assumed, out-of-box organizational design, out-of-box solution documentation and solution materials. A customer or information technology (IT) integrator is provided a graphical user interface (GUI) to edit the out-of-box organizational design to conform to the customer's organizational design. A Documentation Generation and Delivery Tool (DGDT) analyzes both organizational and documentation designs. The DGDT generates and delivers customer-specific documentation based upon out-of-box documentation and customer-specific organizational design. The DGDT also provides a GUI for human interaction. The disclosed techniques may be employed to build dynamic documentation in areas such as, but not limited to, software product info centers, IT solutions, service methods and specific business processes.

### BACKGROUND

Traditionally, software and hardware computing solutions are accompanied by large amounts of documentation. Such documentation is typically comprehensive, organized generically into chapters and sections and provided, in its entirety, to each customer who uses the solution. However, each particular customer differs with respect to aspects such as, but not limited to, team organization, task assignments and skill level.

Some types of documentation are organized around common tasks and might provide help in the form of demonstration movies, cheat sheets, navigation links and keyword or topic search capabilities.

### SUMMARY OF THE CLAIMED SUBJECT MATTER

Provided are techniques for the generation and production of dynamic documentation. As the Inventors herein have realized, although current techniques may mitigate certain problems and improve static, generic documentation currently available, current techniques do no tailor specific documentation to a particular customer's needs.

The disclosed techniques enable a customer or solution provider to generate customer-specific solution documentation according to an organizational design corresponding to a customer from generic, or “out-of-the-box,” documentation. Typically, out-of-the-box documentation is pre-structured based upon a generic out-of-the-box organizational design. Documentation generated according to the disclosed techniques match a customer's environment, roles and tasks with specific customized documentation. Such dynamically created documentation substantially improves the usefulness of solution documentation.

A solution package includes an assumed, out-of-box organizational design, out-of-box solution documentation and solution materials such as but not limited to software tools. Out-of-box solution documentation is structured according to an out-of-box organizational design. A customer or information technology (IT) integrator is provided a graphical user interface (GUI), or “Organization Design Modifier” (ODM), to edit the out-of-box organizational design to conform to the customer's organizational design. In other words, organizational roles are edited to reflect actual responsibilities within the organization, producing a customer-specific organizational design. A Documentation Generation and Delivery Tool (DGDT) analyzes both organizational and documentation designs. In addition, the DGDT generates and delivers customer-specific documentation based upon out-of-box documentation and customer-specific organizational design. The DGDT also provides a GUI for human interaction. The disclosed techniques may be employed to build dynamic documentation in areas such as, but not limited to, software product info centers, IT solutions, service methods and specific business processes.

In one embodiment, a method for producing customer specific documentation comprises generating a first organizational diagram corresponding to an organization implementing the computing solution; correlating each element of the first organization diagram to particular elements of the solution to produce a first organization-to-solution (O2S_{—}1) mapping; transmitting the first organizational diagram, the O2S_{—}1 mapping and the computing solution to the organization; modifying the first organizational diagram to reflect an organizational structure of the organization to produce a second organizational diagram; correlating each element of the second organization diagram to the particular elements of the solution based upon the second organizational diagram and the O2S_{—}1 mapping to produce a second organization-to-solution (O2S_{—}2) mapping; and correlating each element of the O2S_{—}2 mapping to particular elements of documentation corresponding to the computing solution to produce a organizational-to-documentation (O2D) mapping for a distribution of the documentation.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures, in which:

FIG. 1 is a computing system architecture that may be employed to implement the disclosed techniques.

FIG. 2 is a block diagram of a Documentation Generation and Delivery Tool (DGDT), first introduced in FIG. 1, which may implement an aspect of the claimed subject matter.

FIG. 3 is a block diagram of an example of an out-of-box (OOB) organizational design and the conversion of the OOB organizational design into a customer-specific organizational design.

FIG. 4 is an example of a graphical display that shows detail of the OOB organizational design of FIG. 3.

FIG. 5 is an example of an alternative graphical display of the OOB organizational design of FIGS. 3 and 4.

FIG. 6 is an example of a graphical display that shows detail of the customer-specific organizational design of FIG. 3.

FIG. 7 is an example of an alternative graphical display of the customer-specific-organizational design of FIGS. 3 and 6.

FIG. 8 is a flowchart of a Configure OOB Organizational Design (OD) & Documents (DOC) process that may implement aspects of the claimed subject matter.

FIG. 9 is a flowchart of a Customize OD & DOC process that may implement aspects of the claimed subject matter.

### DETAILED DESCRIPTION OF THE FIGURES

Although described with particular reference to business software documentation, the claimed subject matter can be implemented in any information technology (IT) system in which customized documentation is desirable. Those with skill in the computing arts will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for the generation and distribution of customized documentation. The term “programmed method”, as used herein, is defined to mean one or more process steps that are presently performed; or, alternatively, one or more process steps that may be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

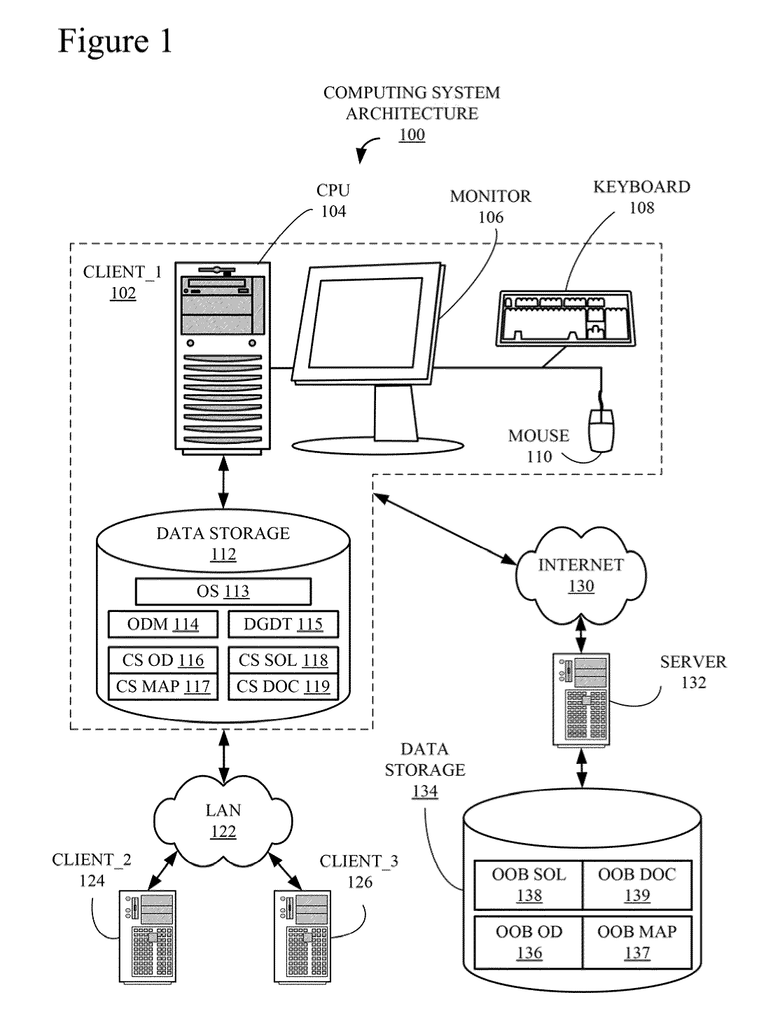

Turning now to the figures, FIG. 1 is a computing system architecture 100 that may be employed to implement the disclosed technique. A first client system, i.e. client_1 102, includes a central processing unit (CPU) 104, coupled to a monitor 106, a keyboard 108 and a mouse 110, which together facilitate human interaction with computing system 100 and client system 102. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

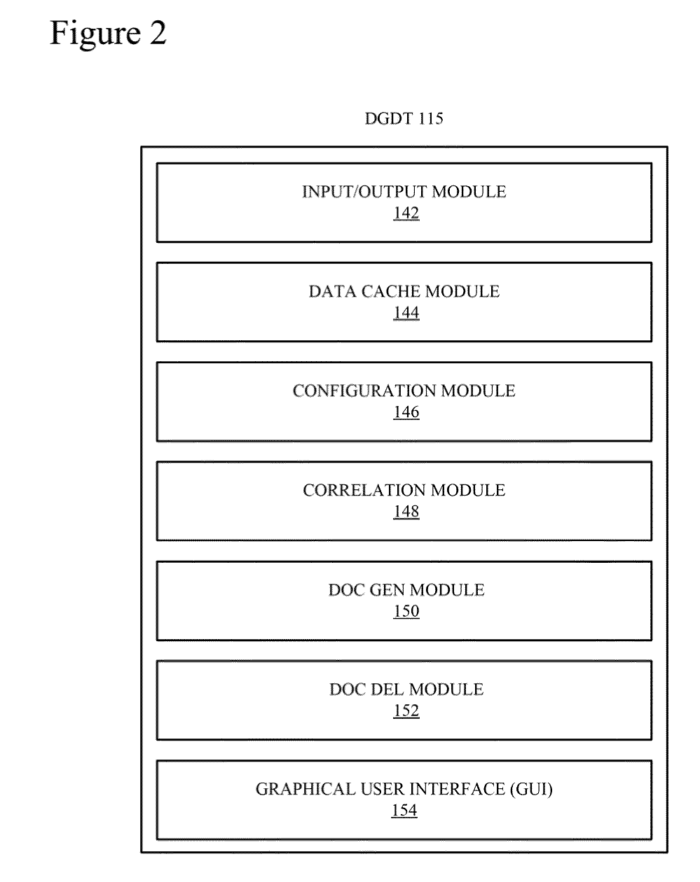

Data storage 112 is illustrated storing an operating system (OS) 113, a Organization Design Modifier” (ODM) 114, a Documentation Generation and Delivery Tool (DGDT) 115, a customer-specific organizational design (CS OD) 116, a customer-specific mapping (CS MAP) 117, a customer-specific solution (CS SOL) 118 and customer-specific documentation (CS DOC) 119. CS SOL 118 may either be a complete computing solution (see OOB SOL 138) or a partial solution corresponding to duties associated with the user of client_1102. In the following examples, CS OD 116 and CS MAP 117 are generated by ODM 114 and CS DOC 119 is generated by DGDT 115. CS MAP 117 stores information that maps tasks associated with CS SOL 0.118 with particular elements of documentation stored in CS DOC 119. OS 113 should be familiar to those with skill in the computing arts and elements 114-119 are described in more detail below in conjunction with FIGS. 2-9. It should be noted that a typical computing system might include many more elements, but for the sake of simplicity only a few are shown.

Client_1 102 is connected to a local area network (LAN) 122 that is coupled to a second and third client system, i.e. a client_2 124 and a client_3 126. Client_1 102 is also coupled to the Internet 130, which is connected to a server computer 132. Although not shown, client_2 124, client_3 126 and server 132 would also include CPUs, monitors, keyboards, mice and OSs like 104, 106, 108, 110 and 113 of client_1 102.

Server 132 is coupled to a data storage 134, which is illustrated storing an out-of-box organizational design (OOB OD) 136, an out-of-box mapping (OOB MAP) 137, an out-of-box solution (OOB SOL 138 and an OOB documentation (OOB DOC) 139. OOB MAP 137 stores information that maps particular documentation elements of OOB DOC 139 with any tasks associated with OOB SOL 138. In this example, OOB OD 136, OOB MAP 137, OOB SOL 138 and OOB DOC 139 are illustrated as stored on a centralized data server from which they may be downloaded to various computing systems such as client_1 102, client_2 124 and client_3 126. It should be understood that this is only one possible configuration, which should be familiar to one with skill in the computing arts. In addition, in this example, client_1 102, client_2 124, client_3 126 and server 132 are communicatively coupled via LAN 122 and the Internet 130, they could also be coupled through any number of communication mediums such as, but not limited to, LAN 122 Internet 130 or another type of network (not shown).

Throughout the following Specification, clients 102, 124 and 126 are used for illustrative purposes as computing systems that may be employed by various users described in CS OD 116. Further, server 132, clients 102, 124 and 126 and elements 113-119 and 136-139 are employed for illustrative purposes to describe the claimed subject matter. Further, it should be noted there are many possible computing system configurations, of which computing system 100 is only one simple example.

FIG. 2 is a block diagram of DGDT 115, first above introduced in FIG. 1, which may implement aspects of the claimed subject matter. DGDT 115 includes an input/output (I/O) module 142, a data cache component 144, a configuration module 146, a correlation module 148, a documentation generation module (Doc Gen) 150, a document delivery module (Doc Del) 152 and a graphical user interface (GUI) module 154.

For the sake of the following examples, DGDT 115 is assumed to be stored on data storage 112 (FIG. 1 and executed on CPU 104 (FIG. 1) of client_1 102 (FIG. 1). It should be understood that the claimed subject matter can be implemented in many types of computing systems and data storage structures but, for the sake of simplicity, is described only in terms of computer 102 and system architecture 100 (FIG. 1). Further, the representation of DGDT 115 in FIG. 2 is a logical model. In other words, components 140, 140, 142, 144, 146, 148, 150, 152 and 154 may be stored in the same or separates files and loaded and/or executed within system 100 either as a single system or as separate processes interacting via any available inter process communication (IPC) techniques.

I/O module 142 handles any communication DGDT 115 has with other components of system 100. Data cache 144 is a data repository for information, including but not limited to settings and configuration information that DGDT 115 requires during normal operation. Configuration module 146 is logic for enforcing various configuration options as defined be parameters stored in data cache 144. Correlation module 148 processes information from OOB OD 136 (FIG. 1), OOB MAP 127, CS OD 116 (FIG. 1) and CS MAP 117 to enable DGDT 115 to convert OOB DOC 139 (FIG. 1) into CS DOC 119 (FIG. 1). Briefly, module 148 compares OOB OD 136 and OOB MAP 117 with CS OD 116 to produce and update CS MAP 117.

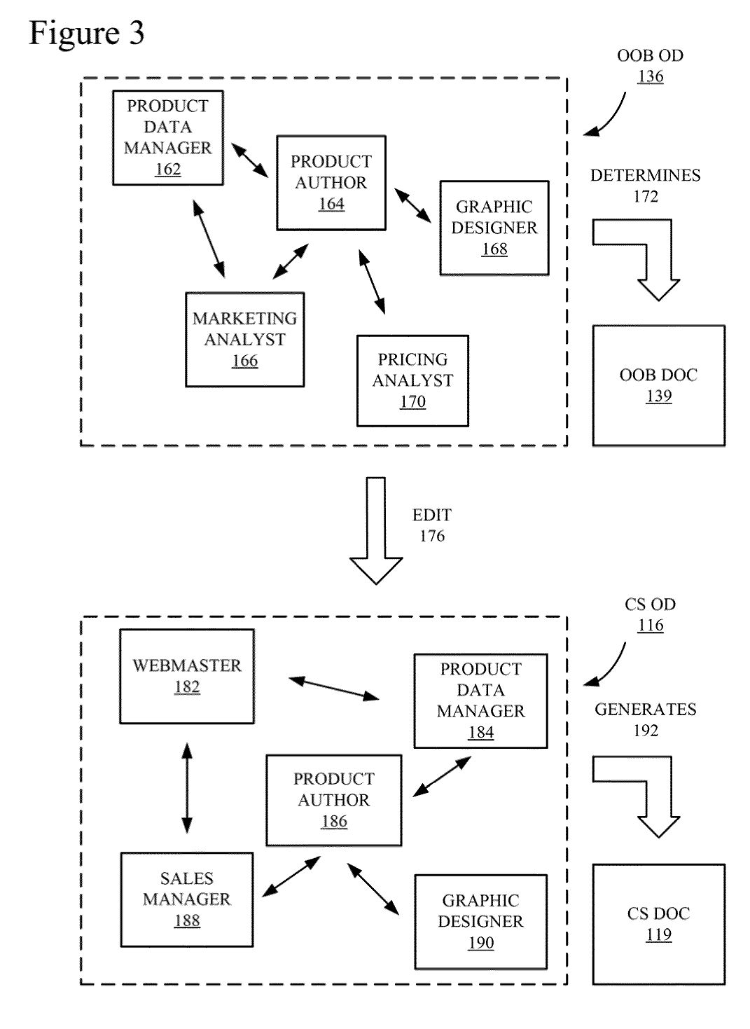

DocGen 150 is logic responsible for the generation of CS Doc 119 based upon the correlation, or mapping CS MAP 117, produced and stored by module 148. Doc Del 152 is logic responsible for the delivery, via I/O module 142, of relevant portions of CS DOC 119 to various users in accordance with the mapping generated by correlation module 148. In this manner, a particular user may receive documentation appropriate for the user's responsibilities and organized in a manner that corresponds to the actual organizational structure of the user's organization. GUI component 158 enables users of DGDT 115 to interact with and to define the desired functionality of DGDT 115. GUI component 154 and components 142, 144, 146, 148, 150 and 152 are described in more detail below in conjunction with FIGS. 3-9.

FIG. 3 is a block diagram of an example of an out-of-box (OOB) organizational design and the flow of a conversion of the OOB organizational design into a customer-specific organizational design. Through out the description of FIG. 3, OOB OD 136 (FIG. 1) is used as an example of an OOB OD; CS OD 116 (FIG. 1) is used as an example of a CS OD; OOB DOC 139 (FIG. 1) is used as an example of an OOB Doc; and CS DOC 119 (FIG. 1) is used as an example of a CS Doc.

Defined user roles of OOB OD 136 include a product data manager 162, a product author 164 a marketing analyst 166, a graphic designer 168 and a pricing analyst 170. In this example, the arrows represent examples of possible interactions between the different roles 162, 164, 166, 168 and 170. The structure defined by roles 162, 164, 166, 168 and 170 determines 172 the structure of OOB DOC 139.

In CS OD 116, the roles illustrated with respect to OOB OD 136 have been redefined. Defined user roles of CS OD 116 include a web master 182, product data manager 184, a product author 186, a sales manager 188 and a graphic designer 190. It should be noted that, although particular roles may have similar titles in OOB OD 136 and CS OD 116, duties associated with a particular role may have been redefined and, therefore, for example, graphic designer 190 is labeled differently than graphic designer 168. In addition, the relationships among the various roles 182, 184, 186, 188 and 190, as illustrated by the arrows, may be redefined.

The transformation of OOB OD 136 into CS OD 116 is accomplished by an editing process 176 executed in conjunction with ODM 114 (FIG. 1). Once CS OD 116 has been defined in conjunction with CS MAP 117 (FIG. 1), a generate process 192 is executed in conjunction with DGDT 115 (FIGS. 1 and 2) to produce CS DOC 119 (FIG. 1)

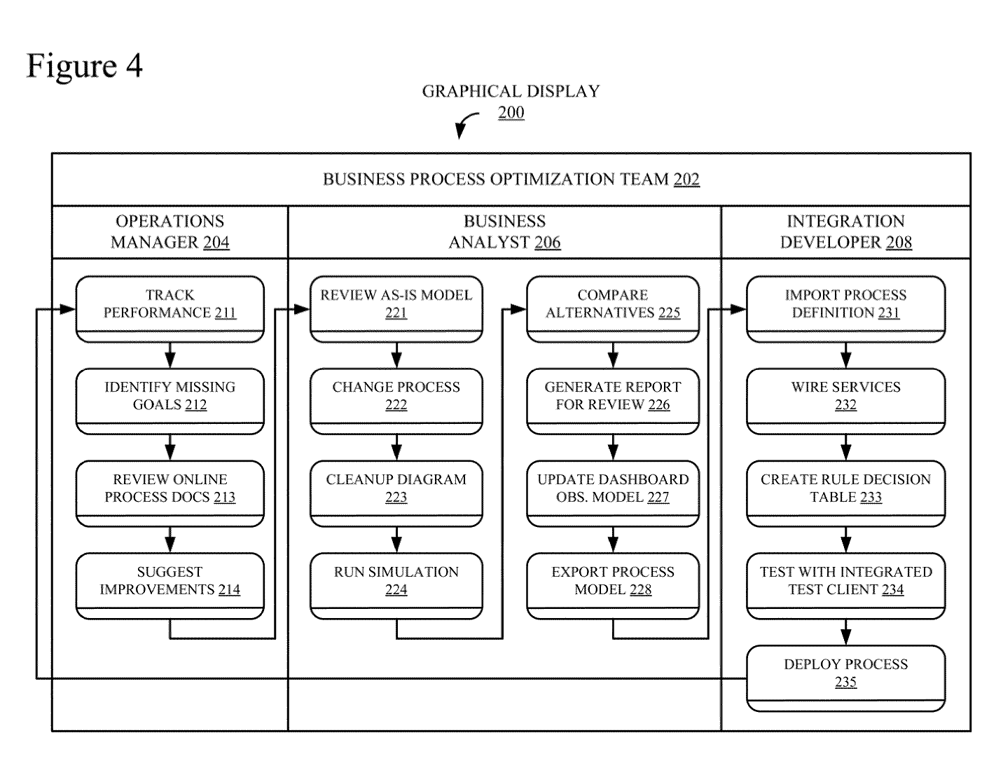

FIG. 4 is an example of a graphical display 200 of a business process optimization team 202 that shows details of a second example of an organizational design corresponding to OOB OD 136 of FIGS. 1 and 3. In this example display 200 may be viewed by a user or IT administrator on monitor 106 (FIG. 1) of client_1 102 (FIG. 1). The display is directed to a Business Process Optimization Team (BPOT) 202, which is employed as one simple example of a type of organizational structure that may utilize the claimed subject matter. In this example, BTOP 202 is organized into three roles, i.e. an Operations Manager 204, a Business Analyst 206 and an Integration Developer 208.

Operations Manager 204 is assigned four (4) tasks, i.e. a Track Performance task 211, an Identify Missing Goals task 212, a Review Online Process Documents task 213 and a Suggest Improvements task 214. Arrows from task to task indicate a preferred order of operation for this particular example. In other words, once task 211 is complete, operations manager 204 proceeds to task 212 and so on.

Business Analyst 206 is assigned eight (8) tasks, i.e. a Review-As-Is Model task 221, a Change Process task 222, a Cleanup Diagram task 223, a Run Simulation task 224, a Compare Alternatives task 225; a Generate Report for Review task 226, an Update Dashboard Observation Model task 227 and an Export Process Model task 228. Integration Developer 208 is assigned five (5) tasks, i.e. an Import Process Definition task 231, a Wire Services task 232, a Create Rule Decision Table task 233, a Test With Integrated Test Client task 234 and a Deploy Process task 235. It should be noted that the specific tasks and roles are for the purpose of example only.

Each of tasks 211-214, 221-228 and 231-235 is associated with roles defined in OOB OD 136. Each task also corresponds to documentation defined in OOB DOC 139. In other words, for each defined task and role, information in OOB OD 136 and OOB DOC 139 correlate the task to a particular role and the specific documentation that supports the task. This information is stored in OOB MAP 137 (FIG. 1) along with information that correlates specific tasks with specific elements of OOB DOC 139.

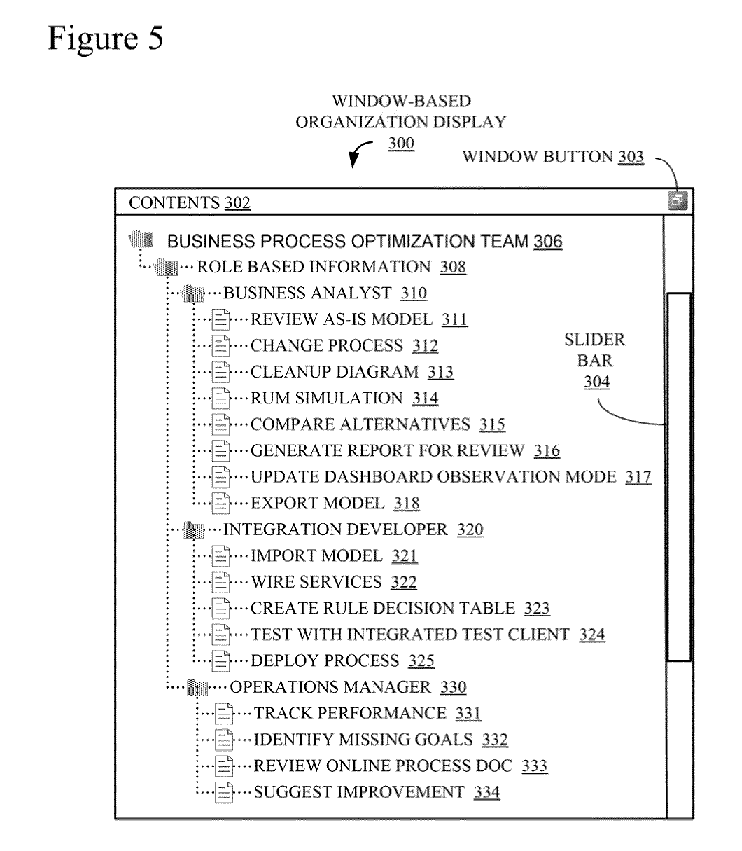

FIG. 5 is an example of an alternative window-based organizational display 300 of the OOB OD 136 of FIGS. 1 and 4, illustrated in a file tree type of structure. Like display 200 (FIG. 4), display 300 may be viewed by a user or IT administrator on monitor 106 (FIG. 1) of client_1 102 (FIG. 1). Display 300 includes a window title 302, i.e. “Contents,” window buttons 303 and a slider bar 304 that enables a user to scroll up and down through window 300. Elements 302-304 should be familiar to those with experience with window-based computing systems.

Like display 200, window 300 lists a Business Process Optimization Team 306 (see 302, FIG. 4) and three roles, i.e. a Business Analyst 310 (see 206, FIG. 4), an Integration Developer 320 (see 208, FIG. 4) and an Operations Manager 330 (see 204, FIG. 4). Business Analyst 310 is assigned eight (8) tasks, i.e. a Review-As-is Model task 311 (see 221, FIG. 4), a Change Process task 312 (see 222, FIG. 4), a Cleanup Diagram task 313 (see 223, FIG. 4), a Run Simulation task 314 (see 224, FIG. 4), a Compare Alternatives task 315 (see 225, FIG. 4), a Generate Report for Review task 316 (see 226, FIG. 4), an Update Dashboard Observation Model task 317 (see 227, FIG. 4) and an Export Process Model task 318 (see 228, FIG. 4). Integration Developer 320 is assigned five (5) tasks, i.e. an Import Process Definition task 321 (see 231, FIG. 4), a Wire Services task 322 (see 232, FIG. 4), a Create Rule Decision Table task 323 (see 233, FIG. 4), a Test With integrated Test Client task 324 (see 234, FIG. 4) and a Deploy Process task 325 (see 235, FIG. 4). Operations Manager 330 is assigned four (4) tasks, i.e. a Track Performance task 331 (see 211, FIG. 4), an Identify Missing Goals task 332 (see 212, FIG. 4), a Review Online Process Documents task 333 (see 213, FIG. 4) and a Suggest Improvements task 334 (see 214, FIG. 4).

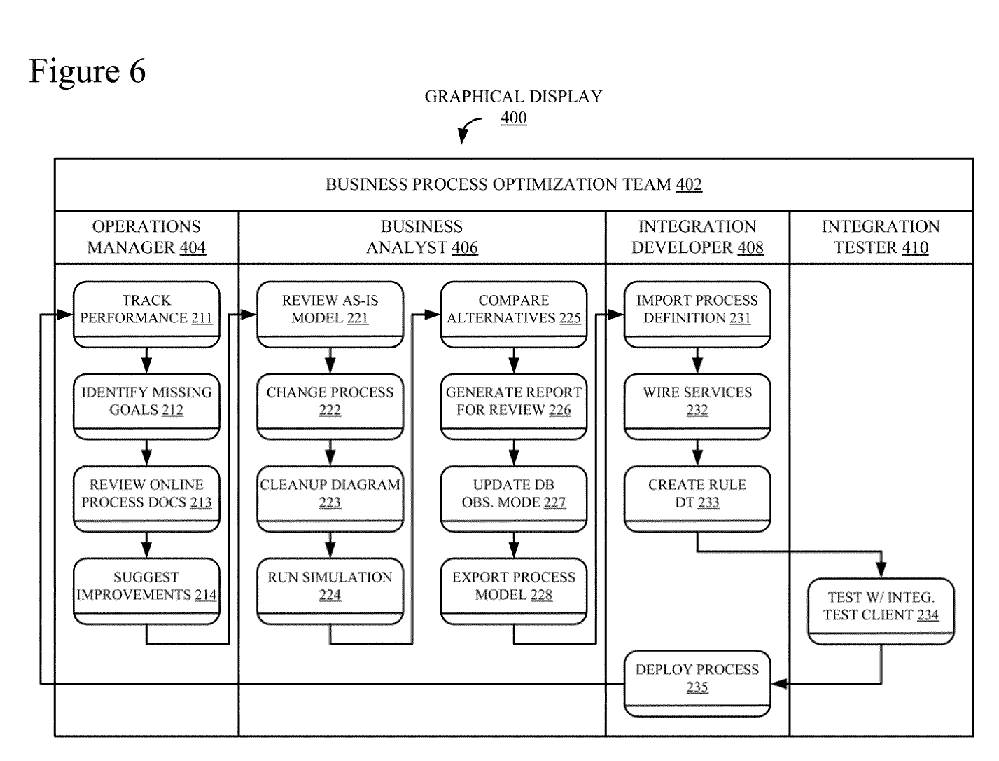

FIG. 6 is an example of a graphical display 400 of a BPOT 402 (see 202, FIG. 4), showing details of an organizational design corresponding to CS OD 116 of FIGS. 1 and 3. In this example, display 400 may be viewed by a user or IT administrator on monitor 106 (FIG. 1) of client_1 102 (FIG. 1). BTOP 402 represents a business organization that has been modified from the organizational structure illustrated in FIG. 4 by employing ODM 114 (FIG. 1) to redefine OOB OD 136 (FIG. 1). Although labels representing roles have been changed from FIG. 4 to FIG. 6, indicating that the roles may have been redefined, labels associated with specific tasks have remained the same to indicate that specific tasks have not been modified. Of course, similar methods may be implemented to redefine tasks. For the sake of simplicity, the granularity of this description only extends to the level of roles.

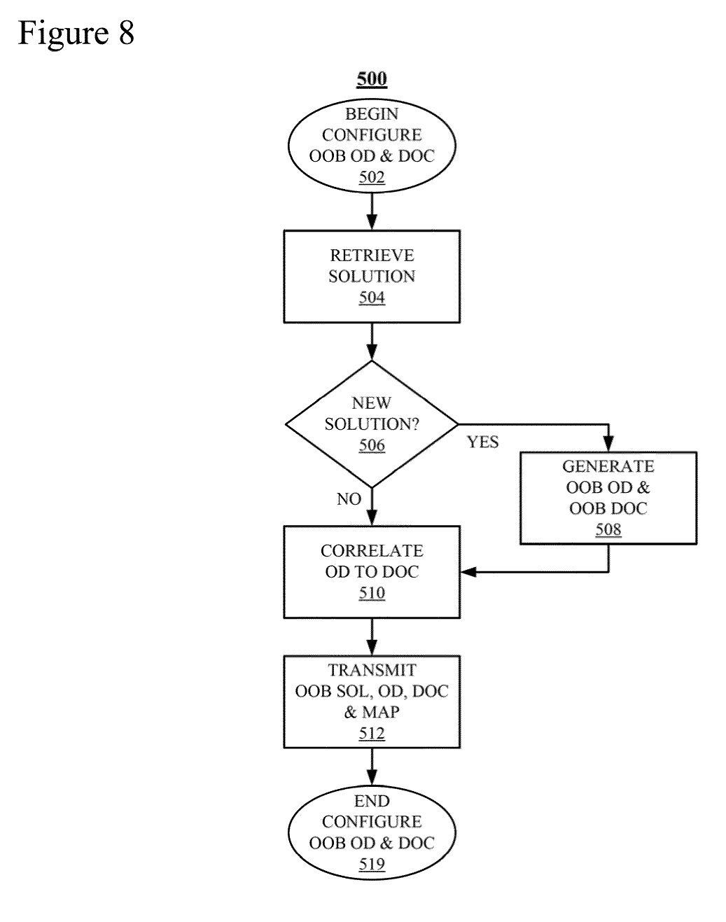

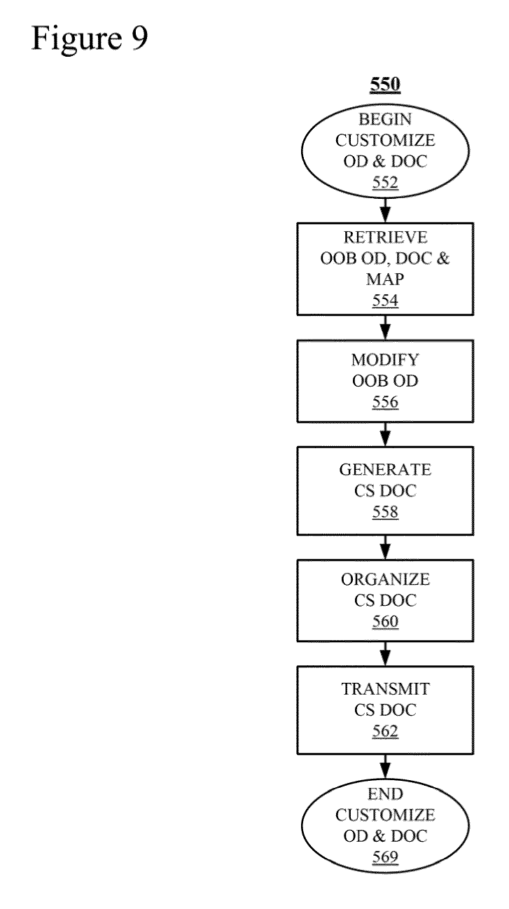

Like BPOT 202 of FIG. 4, BPOT 402 includes three roles, i.e. Operations Manager 404 (see 204, FIG. 4), Business Analyst 406 (see 206, FIG. 4), and Integration Developer 408 (see 208, FIG. 4). In addition, one (1) additional role has been defined, i.e. an Integration Tester 410. Test With Integrated Test Client 234 (FIG. 4) has been reassigned from integration Developer 208 to Integration Tester 410. Tools associated with graphical user interfaces, such as but not limited to “drag and drop” and menu selections, sufficient to specify the changes from BPOT 202 to BPOT 402 should be familiar to those with skill in the computing arts. Processing associated with changes in an organizational structure in accordance with the claimed subject matter as represented by FIGS. 4 and 6 are described below in conjunction with FIGS. 8 and 9.

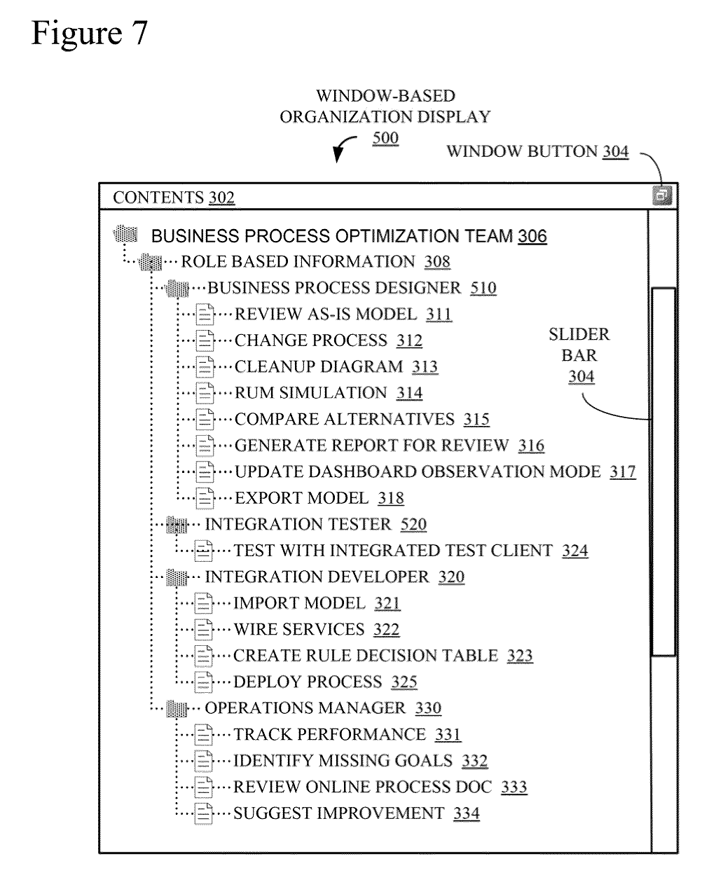

FIG. 7 is an example of a graphical display 500 of a BPOT 402 (see 202, FIG. 4), showing details of an organizational design corresponding to CS OD 116 of FIGS. 1 and 3. Display 500 includes elements of display 300 (FIG. 5), including title 302, window buttons 303 and slider bar 304. In addition, display 500 includes roles 320 and 330 and tasks 311-318, 321-324 and 331-334. Display 500 represents a modification from OOB OD 136 to CS OD 116 as implemented in accordance with the claimed subject matter. In this example, a new role has been defined, i.e. an Integration Tester 520, and the role of Business Analyst 310 (FIG. 5) has been redefined as Business Process Designer 510. In addition, Test With Integrated Test Client 324 has been reassigned from Business Analyst 310 to the newly created role of Integration Test 520.

FIG. 8 is a flowchart of a Configure OOB Organizational Design (OD) & Documents (DOC) process 500 that may implement aspects of the claimed subject matter. In the following example, logic associated with process 500 is executed on server 132 (FIG. 1) to produce OOB OD 136 (FIG. 1) and OOB MAP 139 (FIG. 1). Typically, process 500 is executed by a solution provider.

Process 500 starts in a “Begin Configure OD & Doc” block 502 and proceeds immediately to a “Retrieve Solution” block 504. During block 504, process 500 displays on a monitor (not shown) associated with server 132 tasks (for example, see 311-318, 321-325 and 331-334, FIGS. 5 and 7) associated with the computing solution retrieved during block 504. The definition of tasks associated with an out-of-box solution such as OOB SOL 138, roles associated with an organizational design such as OOB OD 136 (FIG. 1) and the generation of supporting documentation such as OOB DOC 139 are produced by system developers employing an organization design tool (not shown) and a document integrator (not shown).

During a “New Solution?” block 506, process 500 determines whether or not OOB SOL 138 is a product that has not yet been processed according to the disclosed technology. If so, process 500 proceeds to a Generate OOB OD & OOB DOC” block 508 during which OOB DOC 139 is generated based upon OOB OD 136. Once OOB DOC 139 has been generated or, if process 500 determines during block 506 that OOB SOL 138 is not a previously unprocessed solution, control proceeds to a “Correlate OD to DOC” block 510. During block 510, process 500 generates OOB MAP 137 based upon the information in OOB OD 136 and OOB DOC 139 (see 148, FIG. 2). During a “Transmit OOB SOL, OD, DOC & MAP” block 512 process 500 transmits OOB SOL 138, OOB OD 136, OOB DOC 139 and OOB MAP 137 to one or more user's systems such as client_1 102 (FIG. 1), client_2 124 (FIG. 1) and client_3 126 (FIG. 1) (see 152, FIG. 2). Finally, control proceeds to an “End Configure OD & DOC” block 519 in which process 500 is complete.

FIG. 9 is a flowchart of a Customize OD & DOC process 550 that may implement aspects of the claimed subject matter. In this example, logic associated with process 550 is stored on data storage 112 (FIG. 1) and executed on CPU 104 (FIG. 1) of client_1 102 (FIG. 1).

Process 550 starts in a “Begin Customize OD & DOC” block 552 and proceeds immediately to a “Retrieve OOB OD, DOC & MAP” block 554. During block 554, process 550 retrieves OOB OD 136, OOB DOC 139 and OOB MAP 137 from data storage. Elements 136, 137 and 139 may be stored on data storage 134 (FIG. 1) of server 132 (FIG. 1) or on data storage 112 after transmission by server 132 (see 512, FIG. 8).

During a “Modify OOB OD” block 556, a user employs OMT 114 (FIG. 1) to modify OOB OD 136 to produce CS OD 116 by means of the manipulation of graphical displays of tasks and roles (see FIGS. 3-7).

During a “Generate CS DOC” block 558, process 550 executes DGDT 115 to generate CS DOC 119 based upon information stored in CS OD 116 and CS MAP 117. During an “Organize CS DOC” block 560, process 550 arranges the information in CS DOC 119 according to the information of CS MAP 117 so that appropriate documentation may be transmitted to the appropriate corresponding parties. During a “Transmit CS DOC” block 562, portions of CS DOC 119 are transmitted to the appropriate parties. Finally, control proceeds to an “End Customize OD & DOC” block 569 in which process 550 is complete.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method for producing customer specific documentation, comprising:
generating a first organizational diagram corresponding to an organization implementing the computing solution;
correlating each element of the first organization diagram to particular elements of the solution to produce a first organization-to-solution (O2S_{—}1) mapping;
transmitting the first organizational diagram, the O2S_{—}1 mapping and the computing solution to the organization;
modifying the first organizational diagram to reflect an organizational structure of the organization to produce a second organizational diagram;
correlating each element of the second organization diagram to the particular elements of the solution based upon the second organizational diagram and the O2S_{—}1 mapping to produce a second organization-to-solution (O2S_{—}2) mapping; and
correlating each element of the O2S_{—}2 mapping to particular elements of documentation corresponding to the computing solution to produce a organizational-to-documentation (O2D) mapping for a distribution of the documentation.

2. The method of claim 1, further comprising distributing, based upon the O2D mapping, a specific element of the documentation to a specific element represented by the second organizational diagram.

3. The method of claim 2, wherein the distributing is in response to a request for documentation corresponding to the computing solution from the specific element represented by the second organizational diagram.

4. The method of claim 1, wherein the documentation corresponding to the computing solution is transmitted to the organization concurrently with the transmitting of the first organizational diagram, the O2S_{—}1 mapping and the computing solution.

5. The method of claim 1, further comprising:
mapping each element of the computing solution to elements of the documentation to produce a solution-to-documentation (S2D) mapping,
wherein the correlating of each element of the O2S_{—}2 mapping to particular elements of the documentation is based upon the S2D mapping.

6. The method of claim 5, wherein the S2D mapping is transmitted to the organization concurrently with the transmitting of the first organizational diagram, the O2S_{—}1 mapping and the computing solution.

7. The method of claim 1, wherein the distribution is over the Internet.

8. A method for the distribution of customer specific documentation, comprising:
generating a first organizational diagram corresponding to an organization implementing the computing solution;
correlating each element of the first organization diagram to particular elements of the solution to produce a first organization-to-solution (O2S_{—}1) mapping;
transmitting the first organizational diagram, the O2S_{—}1 mapping and the computing solution to the organization;
modifying the first organizational diagram to reflect an organizational structure of the organization to produce a second organizational diagram;
correlating each element of the second organization diagram to the particular elements of the solution based upon the second organizational diagram and the O2S_{—}1 mapping to produce a second organization-to-solution (O2S_{—}2) mapping; and
correlating each element of the O2S_{—}2 mapping to particular elements of documentation corresponding to the computing solution to produce a organizational-to-documentation (O2D) mapping for a distribution of the documentation.

9. The method of claim 8, further comprising distributing, based upon the O2D mapping, a specific element of the documentation to a specific element represented by the second organizational diagram.

10. The method of claim 9, wherein the distributing is in response to a request for documentation corresponding to the computing solution from the specific element represented by the second organizational diagram.

11. The method of claim 8, wherein the documentation corresponding to the computing solution is transmitted to the organization concurrently with the transmitting of the first organizational diagram, the O2S_{—}1 mapping and the computing solution.

12. The method of claim 8, further comprising:
mapping each element of the computing solution to elements of the documentation to produce a solution-to-documentation (S2D) mapping,
wherein the correlating of each element of the O2S_{—}2 mapping to particular elements of the documentation is based upon the S2D mapping.

13. The method of claim 12, wherein the S2D mapping is transmitted to the organization concurrently with the transmitting of the first organizational diagram, the O2S_{—}1 mapping and the computing solution.

14. A system for the distribution of customer specific documentation, comprising:
a processor;
a physical memory coupled to the processor; and
logic, stored on the memory and executed on the processor, for:
generating a first organizational diagram corresponding to an organization implementing the computing solution;
correlating each element of the first organization diagram to particular elements of the solution to produce a first organization-to-solution (O2S_{—}1) mapping;
transmitting the first organizational diagram, the O2S_{—}1 mapping and the computing solution to the organization;
modifying the first organizational diagram to reflect an organizational structure of the organization to produce a second organizational diagram;
correlating each element of the second organization diagram to the particular elements of the solution based upon the second organizational diagram and the O2S_{—}1 mapping to produce a second organization-to-solution (O2S_{—}2) mapping; and
correlating each element of the O2S_{—}2 mapping to particular elements of documentation corresponding to the computing solution to produce a organizational-to-documentation (O2D) mapping for a distribution of the documentation.

15. The system of claim 14, the logic further comprising logic for distributing, based upon the O2D mapping, a specific element of the documentation to a specific element represented by the second organizational diagram.

16. The system of claim 15, wherein the distributing is in response to a request for documentation corresponding to the computing solution from the specific element represented by the second organizational diagram.

17. The system of claim 14, wherein the documentation corresponding to the computing solution is transmitted to the organization concurrently with the transmitting of the first organizational diagram, the O2S_{—}1 mapping and the computing solution.

18. The system of claim 14, the logic further comprising logic for:
mapping each element of the computing solution to elements of the documentation to produce a solution-to-documentation (S2D) mapping,
wherein the correlating of each element of the O2S_{—}2 mapping to particular elements of the documentation is based upon the S2D mapping.

19. The system of claim 18, wherein the S2D mapping is transmitted to the organization concurrently with the transmitting of the first organizational diagram, the O2S_{—}1 mapping and the computing solution.

20. A computer programming product for the distribution of customer specific documentation, comprising:
a physical memory; and
logic, stored on the memory for execution on a processor, for:
generating a first organizational diagram corresponding to an organization implementing the computing solution;
correlating each element of the first organization diagram to particular elements of the solution to produce a first organization-to-solution (O2S_{—}1) mapping;
transmitting. the first organizational diagram, the O2S_{—}1 mapping and the computing solution to the organization;
modifying the first organizational diagram to reflect an organizational structure of the organization to produce a second organizational diagram;
correlating each element of the second organization diagram to the particular elements of the solution based upon the second organizational diagram and the O2S_{—}1 mapping to produce a second organization-to-solution (O2S_{—}2) mapping; and
correlating each element of the O2S_{—}2 mapping to particular elements of documentation corresponding to the computing solution to produce a organizational-to-documentation (O2D) mapping for a distribution of the documentation.

21. The computer programming product of claim 20, the logic further comprising logic for distributing, based upon the O2D mapping, a specific element of the documentation to a specific element represented by the second organizational diagram.

22. The computer programming product of claim 21, wherein the distributing is in response to a request for documentation corresponding to the computing solution from the specific element represented by the second organizational diagram.

23. The computer programming product of claim 20, wherein the documentation corresponding to the computing solution is transmitted to the organization concurrently with the transmitting of the first organizational diagram, the O2S_{—}1 mapping and the computing solution.

24. The computer programming product of claim 20, the logic further comprising logic for:
mapping each element of the computing solution to elements of the documentation to produce a solution-to-documentation (S2D) mapping,
wherein the correlating of each element of the O2S_{—}2 mapping to particular elements of the documentation is based upon the S2D mapping.

25. The computer programming product of claim 24, wherein the S2D mapping is transmitted to the organization concurrently with the transmitting of the first organizational diagram, the O2S_{—}1 mapping and the computing solution.
